(19) United States
(12) Patent Application Publication
(10) Pub. No.: US 2004/0245002 A1
(43) Pub. Date: Dec. 9, 2004

(54) Screw-rod locking structure for attachment fixture

(76) Inventor: Shingo Muroto, Komatsu-shi (JP)

Correspondence Address: HARNESS, DICKEY & PIERCE, P.L.C., P.O. BOX 828, BLOOMFIELD HILLS, MI, 48303, US

(21) Appl. No.: 10/457,072

(22) Filed: Jun. 6, 2003

(51) Int. Cl. A01B 51/00

(52) U.S. Cl. 172/272

(57) ABSTRACT

An attachment fixture includes a pair of first link plates including a connection pin for pivotally connecting an attachment to the boom tip of the power shovel; a pair of second link plates located opposed to the first link plates and including a connection pin for pivotally connecting the second link plates to a front link of the power shovel. Upper portions of the first and second link plates are connected to each other by pivot pins. U-shaped slots are formed at lower portions of the first and second link plates for fastening the first and second link plates to pins of the attachment. The U-shaped slots are located back-to-back with each other. A screw rod is mounted on the attachment fixture to open and close the first and second link plates. The screw rod has a hexagonal screw head. A lock plate is fitted over the screw head. A double ring is mounted on the screw head to prevent the screw rod from being loosened.

### BACKGROUND OF THE INVENTION

1. Field of the Invention

The present invention relates to a fixture interposed between the tip of a boom of a power shovel and an attachment for the power shovel such as a bucket, grab pawls, a vibratory crusher or the like, so that the attachment can be detachably mounted on the power shovel or replaced by another attachment in a simple and rapid manner. Particularly, the present invention concerns an attachment fixture characterized by a locking structure of a screw rod which is mounted between the boom and front link of the power shovel to fix an attachment to the power shovel.

2. Description of Related Art

Power shovels are broadly used in the field of various civil engineering works and designed to carry any of various attachments such as grab pawl device and vibratory crusher depending on their work, in addition to excavating buckets originally installed to the power shovels.

In a small-scale job, only one power shovel is frequently used to carry out various types of working. Such a small-scale job requires the replacement of one attachment to another depending on the type of work.

An attachment fixture has been used conventionally to carry out this replacement simply and rapidly.

The attachment fixture includes opposed members movable relative to each other, as shown in FIGS. 8 and 9.

In such a fixture as shown in FIG. 8, one of the opposed members is a base 103A while the other member is a slider 101A on the base 103. The opposed members 101A, 103A are mounted on the power shovel by pivotally connecting the base end potion thereof with both boom 81 and front link 82 through pins 114 and 134.

In such a fixture as shown in FIG. 9, one of the opposed members is a link plate 101B while the other member is another link plate 103B. These link plates 101B, 103B are mounted on the power shovel by pivotally connecting the base end portion thereof with both the boom 81 and front link 82 through pins 114 and 134.

U-shaped slot 116 is provided at free end portions of the opposed members 101A and 103B. In the same manner, u-shaped slot 136 is provided at free end portions of the opposed members 101B and 103B. The U-shaped slots 116 and 136 are faced each other or back-to-back. A screw rod 105 is provided which is used to adjust the spacing therebetween.

A case wherein a bucket is used as an attachment will be described. Pins 61 and 62 have previously been mounted on a bucket 6. The U-shaped slots 116, 136 are then positioned opposing the pins 61 and 62 of the bucket, respectively. The opposed members 101A, 103A in FIG. 8 are then moved in a direction in which the spacing therebetween is reduced. Instead, the opposed members 101B, 103B in FIG. 9 are then moved in the opposite direction in which the spacing therebetween is increased. The pins 61 and 62 are then inserted into the respective U-shaped slots 116 and 136. The bucket 6 will be fixed by applying a tensile or compressive force between the opposed members through the screw rod 105.

When the bucket is mounted on the power shovel through such a fixture and if the screw rod 105 in this fixture loosens, unstableness is caused in the connection with the bucket. At the worst, the bucket may drop from the power shovel. This is extremely dangerous.

Thus, the screw rod 105 must be locked against rotation after the bucket 6 has been fixed.

Various anti-rotating structures are known in the art. However, there is still a need for a more secure anti-rotating structure since a large vibration or impact may be repeatedly exerted onto the bucket fixture during work and since a large external force may act on the working bucket fixture in an unexpected direction.

FIG. 10 shows an anti-rotating device according to a conventional art in which a lock plate 107 is fitted over the hexagonal screw head of a screw rod. A split pin 154 is inserted into a pin bore (not shown) formed through the screw head-of the screw rod along an axis perpendicular to the longitudinal axis thereof. Thus, the lock plate 107 will not be removed unintentionally from the screw head. As a result, the bucket can be prevented from unexpectedly dropping from the power shovel.

There is also known a locking method using a ring-shaped springback locking tool 150 as shown in FIG. 11A.

This method prevents the attachment from dropping from the power shovel by fitting a lock plate 107 over the screw head 151 of a screw rod, inserting a pin 155 into a pin bore (not shown) formed through the screw head and turning a ring spring 156 in the locking tool 150 over the lock plate 107 to prevent it from being unintentionally removed from the screw head 151.

FIG. 11B shows an enlarged side view of this locking tool 150 in which the lock plate 107 is locked relative to the screw head 151.

In such a conventional screw-rod locking structures, however, the split pin 154 may be unintentionally removed from the screw head 151 by scattered stones or the ring-shaped springback locking tool 150 may be turned back to permit the removal of pin 155 by stones or the like entered into the clearance between the ring spring 156 and the lock plate 107.

### BRIEF SUMMARY OF THE INVENTION

The present invention may provide an attachment fixture of such a structure that can surely prevent a screw rod from being loosened even through a large external force or vibration.

A first aspect of the present invention relates to an attachment fixture for mounting an attachment on a boom tip of a power shovel, comprising:

a pair of link plates including a first connection pin for pivotally connecting an attachment to the boom tip of the power shovel;

a pair of second link plates located opposed to the first link plates and including a second connection pin for pivotally connecting the second link plates to a front link of the power shovel, upper portions of the first and second link plates being connected to each other by pivot pins;

U-shaped slots formed at lower portions of the first and second link plates for fastening the first and second link plates to pins of the attachment, the U-shaped slots being located back-to-back with each other;

a screw rod mounted on the attachment fixture to open and close the first and second link plates, the screw rod having a hexagonal screw head;

a lock plate fitted over the screw head; and

a double ring mounted on the screw head to prevent the screw rod from being loosened.

A second aspect of the present invention relates to an attachment fixture for mounting an attachment on a boom tip of a power shovel, comprising:

a pair of first left and right link plates including a first connection pin for pivotally connecting an attachment to the boom tip of the power shovel;

a pair of second link plates located opposed to the first link plates and including a second connection pin for pivotally connecting the second link plates to a front link of the power shovel, upper portions of the first and second link plates being connected to each other by pivot pins;

U-shaped slots formed at lower portions of the first and second link plates for fastening the first and second link plates to pins of the attachment, the U-shaped slots being located back-to-back with each other;

a screw rod mounted on the attachment fixture to open and close the first and second link plates, the screw rod having ahexagonal screw head; and

a lock plate fixed by at least one fastening member to the attachment fixture to prevent the screw rod from being loosened, external shape of the lock plate being square.

The bucket fixture according to the present invention can surely mount the bucket on the power shovel with higher rigidity and will not create any looseness in the bucket fixture even if a large vibration or impact is exerted onto the fixture or even by flying stones.

In addition, the bucket fixture of the present invention is of simplified structure and enables attachment and separation of the bucket in simple and rapid manner.

Since the hexagonal screw head in the screw rod is engaged with the lock plate and locked through the double ring inserted thereinto to prevent the screw rod from being loosened. This double ring will not drop unintentionally from the screw head once the double ring is mounted into the mount bore formed in the screw head in a direction substantially perpendicular to the longitudinal axis of the screw head.

Since the hexagonal screw head of the screw rod is fitted into the lock plate and since the external shape of the lock plate is square and the lock plate is fastened by fastening member such as bolt, the screw rod can surely be fixed at every 30 degrees.

### BRIEF DESCRIPTION OF THE SEVERAL VIEWS OF THE DRAWING

FIG. 1 is an elevation view of an attachment fixture according to the present invention.

FIG. 2 is a partially sectional view of the attachment fixture.

FIG. 3 is an exploded view of the primary part of a locking device.

FIGS. 4A , 4B, 4C and 4D are a top plan view of a double ring, a side view of the double ring as viewed from an arrow A, another side view of the double ring as viewed from an arrow B and still another side view of the double ring as viewed from an arrow C, respectively.

FIG. 5 is a perspective view of the double ring.

FIG. 6 shows the relationship between a lock plate and a hexagonal head bolt.

FIGS. 7A to 7E show various positions of the bolt in which the screw rod will not be unlocked.

FIG. 8 shows a method of mounting an attachment on a power shovel.

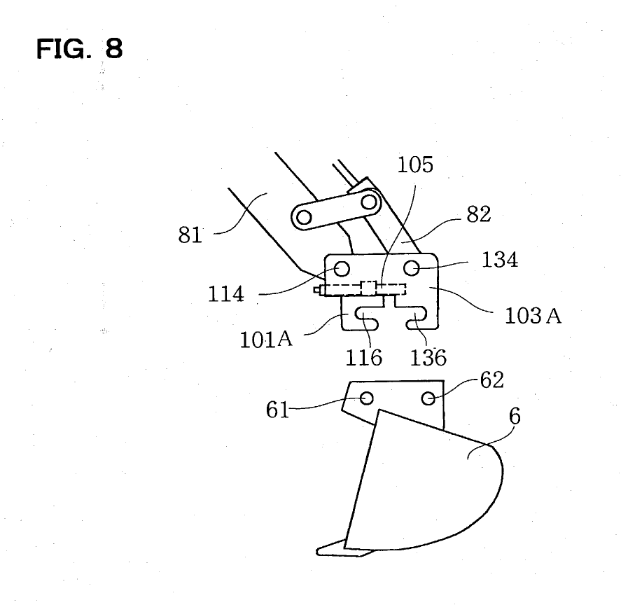

FIG. 9 shows another method of mounting the attachment on the power shovel.

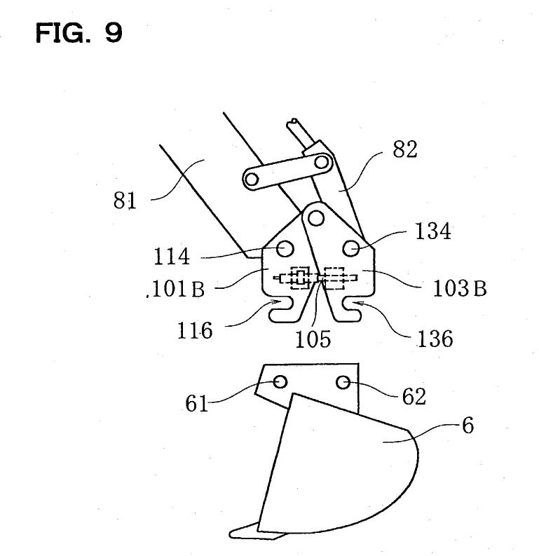

FIG. 10 shows a conventional method of locking an attachment by a fixing screw rod.

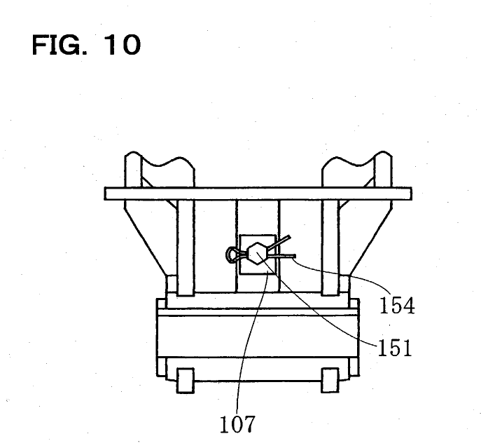

FIGS. 11A and 11B show another conventional method by which an attachment is locked by a fixing screw rod.

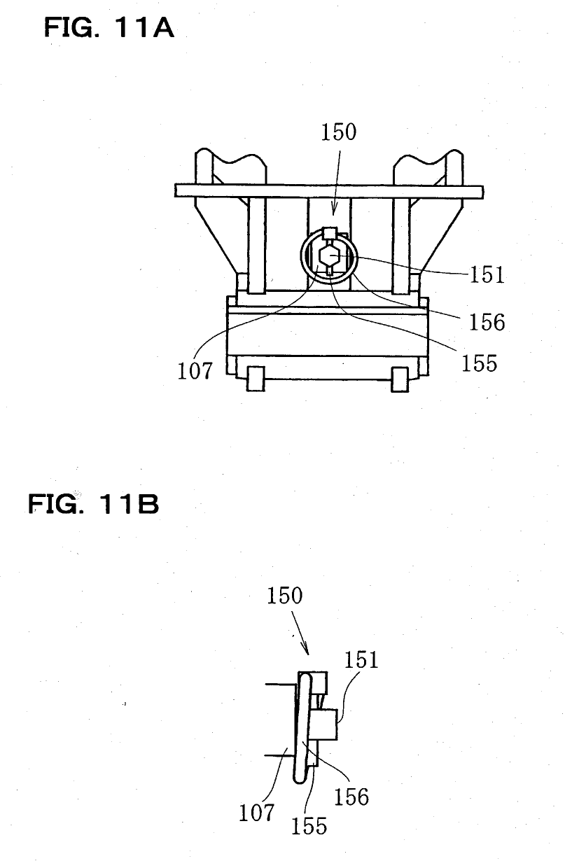

### DETAILED DESCRIPTION OF THE EMBODIMENT

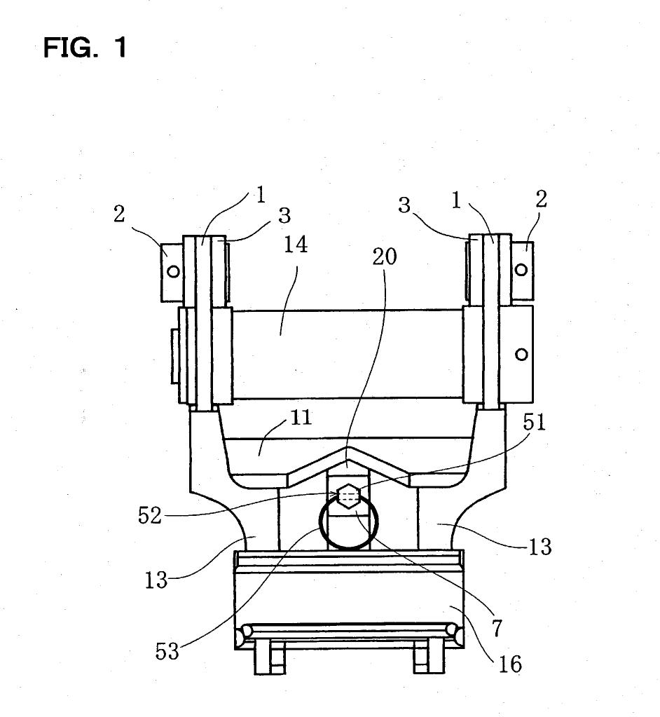

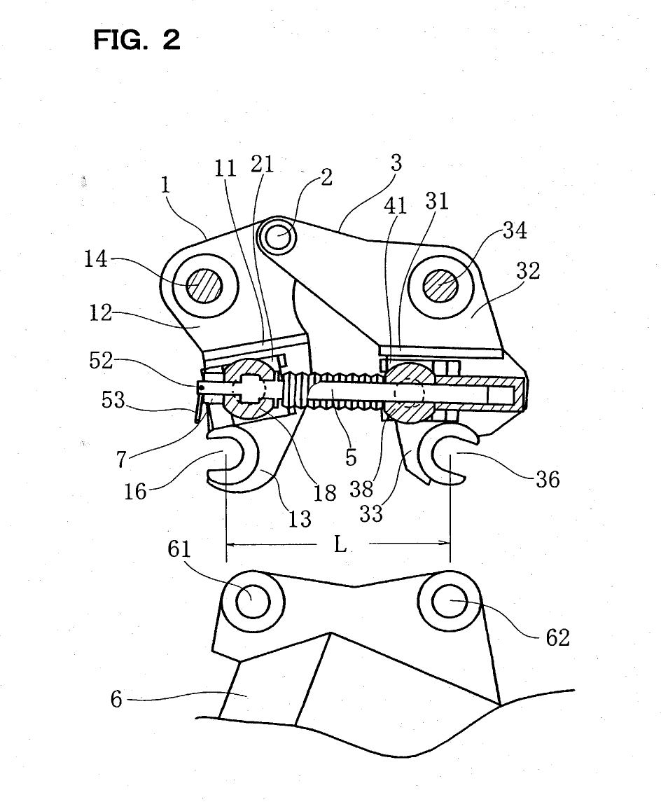

FIG. 1 is an elevation view of an attachment fixture according to the present invention while FIG. 2 is a cross-sectional view taken along a central plane.

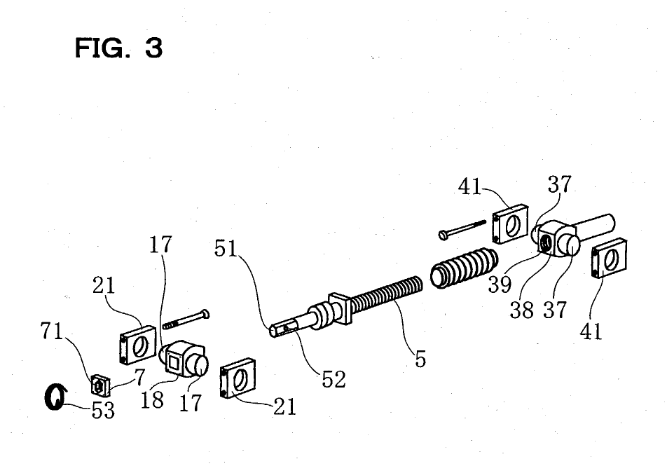

Moreover, FIG. 3 is an exploded view of the primary part of a locking device.

The attachment fixture includes two pairs of left and right opposed link plates 1 and 3. As shown in FIG. 1, the link plates 1 and 1 are connected with each other through a connection 11. In the same manner, the link plates 3 and 3 are connected with each other through another connection 31. The entire configuration of the attachment fixture has a shape of channel with its open top.

Pins 14 and 34 for pivotally mounting an attachment fixture such as bucket on the boom and front link of the power shovel, extend through upper plates 12 and 32 of the link plates at the middle region thereof.

U-shaped slots 16 and 36 for fastening the fixture to pins 61 and 62 in a bucket 6 are formed in the respective link plates 1 and 3 at the bottom ends 13 and 33.

The link plates 1 and 3 are interconnected by pivotally connecting between the upper plate to be located respectively on the opposite sides of the boom or front link in the power shovel through a short pivot pin 2. The link plates 1 and 3 in each set rotate relative to each other about this short pivot pin 2 to increased or decrease the spacing L between the U-shaped slots 16 and 36.

The pair of link plates 1 and 1 pivotally support a trunnion at the middle positions thereof through pin 17 laterally extending from block 18 in that trunnion as shown in FIGS. 2 and 3. The other pair of link plates 3 and 3 pivotally support a trunnion at the middle positions thereof through pin 37 laterally extending from block 37 in that trunnion as shown in FIG. 3.

A screw rod 5 is mounted at one end in the block 18 of the trunnion supported by the link plates pair 1 and 1 rotatably but against movement in the axial direction. The other end of this screw rod 5 threadedly engages into a screw bore 39 in the block 38 of the trunnion supported by the other or the link plates pair 3 and 3.

A base end portion of the screw head 5 (on the side of the block 18 by which it is pivotally supported for rotation, but against movement in the axial direction) is provided with a hexagonal head 51. By rotating the screw rod 5 through a box spanner or the like engaging this hexagonal screw head 51, the distance L between the U-shaped slots 16 and 36 can be increased or decreased for fixation or removal of the bucket 6.

A pin bore 52 is formed through the screw head 51 in a direction perpendicular to the longitudinal axis thereof.

The fixation of the screw rod 5 is carried out by fitting a lock plate 7 over the screw head 51 and inserting a double ring 53 through a pin bore 52, thereby preventing the dropping of the lock plate 7. The lock plate 7 is of a square configuration fittable into a slit 20 (see FIG. 1) and has an opening of regular hexagon centrally formed in for engaging with the screw head 51.

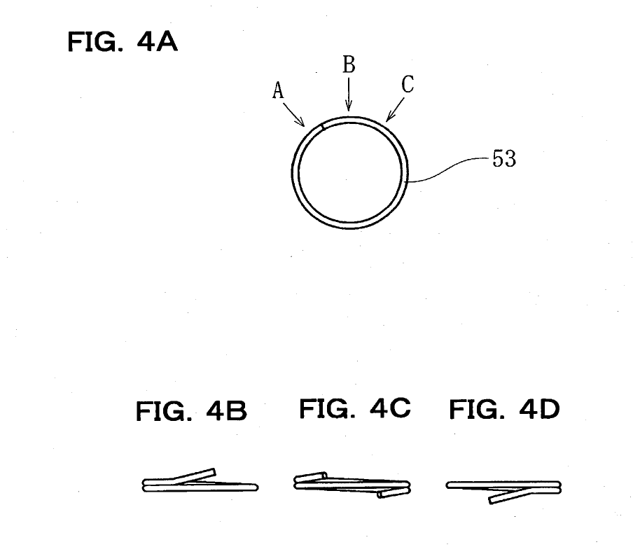

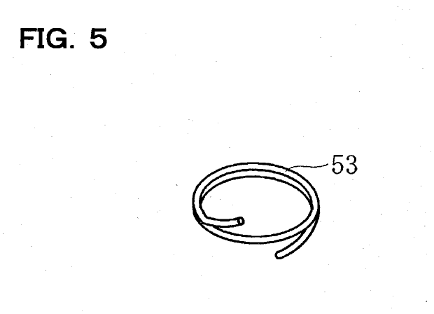

A structure of the double ring 53 is shown in FIGS. 4 and 5.

In FIGS. 4A, 4B and 4C are side views of the double ring 53 as viewed from arrows A, B and C, respectively. FIG. 5 is a perspective view of the double ring 53.

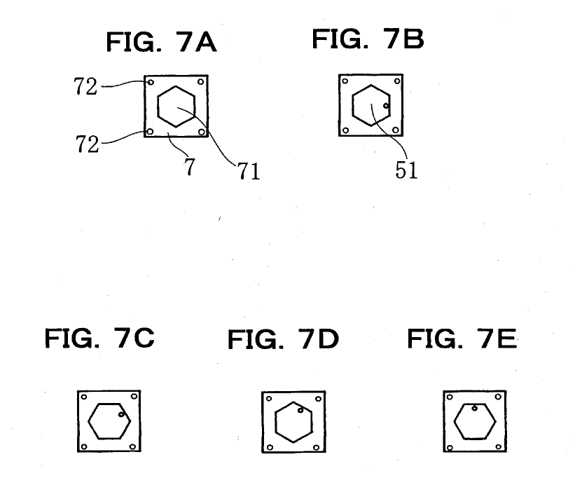

The lock plate 7 also includes a bore 71 of regular hexagon centrally formed therein as shown in FIG. 7A and fastening holes 72 such as bolt holes formed in the lock plate 7 at four corners thereof.

The lock plate 7 can be placed and fixed at every 30 degrees by rotating the lock plate 7 under the relationship between the square lock plate 7 and the screw head 51 of the screw rod 5 fitted into the bore 71 thereof, as shown in FIGS. 7B, 7C, 7D and 7E.

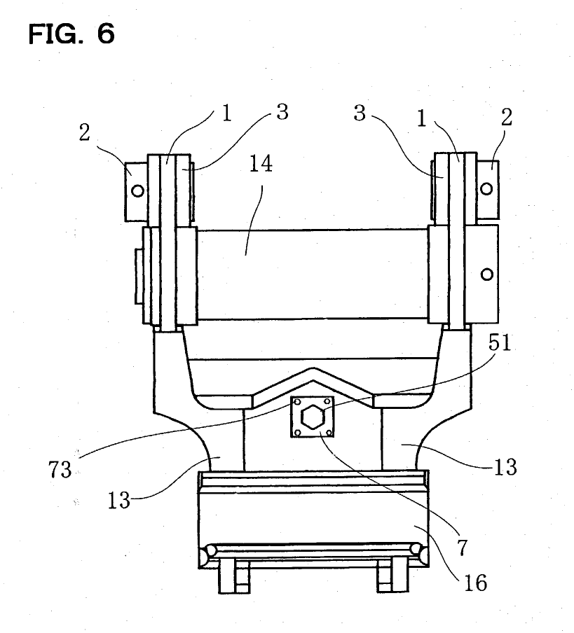

If the lock plate is fastened directly to the fixture through fastening members 73 such as bolts as shown in FIG. 6, it is not necessary to mount the double ring 53 on the screw head.

Mounting process of the bucket 6 on the fixture will be described below.

First of all, the screw rod 5 is rotated by a box spanner or the like in a direction in which the spacing L between the U-shaped slots 16 and 36 decreases. One of the pins 61 and 62 in the bucket 6 is then inserted into the corresponding one of the U-shaped slots, with the other pin 62 or 61 being positioned to oppose the other U-shaped slot.

When the screw rod 5 is rotated in the opposite direction in which the spacing L between the U-shaped slots increases under such a state, the two pins 61 and 62 of the bucket are inserted into both of the U-shaped slots 16 and 36.

Finally, the U-shaped slits 16 and 36 are urged to engage the corresponding one of the pins 61 and 62 in a direction in which the pins 61 and 62 are away from each other, thereby fastening the bucket 6 to the fixture.

In this state, the screw head 51 of the screw rod 5 is then fitted into the hexagonal bore 71 of the lock plate 7 through the slit 20.

Since the screw head 51 is fittable into the bore 71 of the lock plate 7 every time the screw head 51 rotates by 30 degrees, the locking device used in the fixture can reduce the amount of turn in the screw rod 5 for aligning the screw head 51 with the orientation of the lock plate bore 71. Therefore, the bucket 6 can surely be fixed to the power shovel boom with high rigidity.

If the lock plate 7 has been properly positioned in such a manner, the double ring 53 is then inserted into the pin bore 52 in the screw head 51 to lock the lock plate 7, whereby the mount of the bucket 6 can be completed.

The lock plate 7 is held by inserting the double ring 53 into the pin bore 52 in the screw head 5. The double ring 53 will not be removed unintentionally out of the pin bore 52 even by flying stones, thereby surely preventing the lock plate 7 from being dropping from the power shovel boom.

Moreover, the lock plate 7 may be fastened directly to the fixture through bolts 73 or the like.

1. An attachment fixture for mounting an attachment on a boom tip of a power shovel, the attachment fixture comprising:
a pair of first link plates including a first connection pin for pivotally connecting an attachment to the boom tip of the power shovel;
a pair of second link plates located opposed to the first link plates and including a second connection pin for pivotally connecting the second link plates to a front link of the power shovel, upper portions of the first and second link plates being connected to each other by pivot pins;
U-shaped slots formed at lower portions of the first and second link plates for fastening the first and second link plates to pins of the attachment, the U-shaped slots being located back-to-back with each other;
a screw rod mounted on the attachment fixture to open and close the first and second link plates, the screw rod having a hexagonal screw head;
a lock plate fitted over the screw head;
a slit for receiving and anti-rotating the lock plate; and
a double ring mounted on the screw head to prevent the screw rod from being loosened.

2. (Cancelled).

3. An attachment fixture for mounting an attachment on a boom tip of a power shovel, the attachment fixture comprising:
a pair of first left and right link plates including a connection pin for pivotally connecting an attachment to the boom tip of the power shovel;
a pair of second link plates located opposed to the first link plates and including a connection pin for pivotally connecting the second link plates to a front link of the power shovel, upper portions of the first and second link plates being connected to each other by pivot pins;
U-shaped slots formed at lower portions of the first and second link plates for fastening the first and second link plates to pins of the attachment, the U-shaped slots being located back-to-back with each other;
a screw rod mounted on the attachment fixture to open and close the first and second link plates, the screw rod having a hexagonal screw head; and
a lock plate including a bore of regular hexagon centrally formed therein for receiving the screw head and fixed by at least one fastening member to the attachment fixture to prevent the screw rod from being loosened.

4. (Cancelled).

5. An attachment fixture for mounting an attachment on a boom tip of a power shovel, the attachment fixture comprising:
a pair of first left and right link plates including a connection pin for pivotally connecting an attachment to the boom tip of the power shovel;
a pair of second link plates located opposed to the first link plates and including a connection pin for pivotally connecting the second link plates to a front link of the power shovel, upper portions of the first and second link plates being connected to each other by pivot pins;
U-shaped slots formed at lower portions of the first and second link plates for fastening the first and second link plates to pins of the attachment, the U-shaped slots being located back-to-back with each other;
a screw rod mounted on the attachment fixture to open and close the first and second link plates, the screw rod having a hexagonal screw head; and
a lock plate fixed by at least one fastening member to the attachment fixture to prevent the screw rod from being loosened, external shape of the lock plate being square,
wherein the lock plate includes fastening holes at four corners thereof.
